(19) United States
(12) Patent Application Publication
(10) Pub. No.: US 2024/0177465 A1
(43) Pub. Date: May 30, 2024

(54) GEOLOGICAL TARGET IDENTIFICATION METHOD AND APPARATUS BASED ON IMAGE INFORMATION FUSION

(71) Applicants: Guoqiang XUE, Beijing (CN); Pengfei LV, Beijing (CN); Xin WU, Beijing (CN); Weiying CHEN, Beijing (CN)

(72) Inventors: Guoqiang XUE, Beijing (CN); Pengfei LV, Beijing (CN); Xin WU, Beijing (CN); Weiying CHEN, Beijing (CN)

(21) Appl. No.: 18/071,663

(22) Filed: Nov. 30, 2022

(51) Int. Cl. G06V 10/80; G06T 3/40; G06T 5/50; G06T 7/10; G06T 7/50; G06T 7/90; G06V 20/10

(52) U.S. Cl. CPC G06V 10/803; G06T 3/40; G06T 5/50; G06T 7/10; G06T 7/50; G06T 7/90; G06V 20/10; G06T 2207/10024; G06T 2207/10028; G06T 2207/20221; G06T 2207/30181

(57) ABSTRACT

Provided are a geological target identification method and apparatus based on image information fusion. The method includes: generating a first digital sectional map and a second digital sectional map of the same depth from a first data volume and a second data volume, respectively; configuring data of the first digital sectional map and the second digital sectional map on a universal coordinate system to form a first registered color map and a second registered color map; pre-processing the first registered color map and the second registered color map to form a first source image and a second source image; decomposing the first source image and the second source image respectively into a low frequency sub-band image and a high frequency sub-band image; fusing the two low frequency sub-band images; fusing the two high frequency sub-band images, reconstructing the fused low frequency sub-band image and the fused high frequency sub-band image, and segmenting the occurrence position of a geological body in the fused image by using a segmentation method to obtain a spatial occurrence form of a detection target.

### FIELD OF THE INVENTION

The present invention relates to the technical field of geophysical exploration, in particular to a geological target identification method and apparatus based on image information fusion.

### BACKGROUND OF THE INVENTION

Earth media generally have multiple physical properties. It is an important task for geophysical exploration to depict underground targets more comprehensively and accurately by comprehensively utilizing multiple physical parameters such as electrical properties, magnetism and density of media. Traditionally, geophysical technicians make subjective judgments on various geophysical physical image data according to their experience and knowledge. For the same data set, different people may obtain different conclusions. In 1970s, Vozoff and Juppp (1975) first proposed the geophysical joint inversion theory. At present, joint inversion is an effective means to solve the problems of inconsistency of inversion structures and low utilization of multiple data. However, joint inversion needs to bring multiple data into the same inversion calculation. Then, a matrix with huge dimensions, which is complicated in calculation and difficult to solve, is usually produced. With the demand of exploration turning to complex terrain exploration in large depth and large area, data are usually collected by means of a flight platform, and the quantity of data obtained is quite huge, so it is more difficult to obtain a model close to the real underground structure by using the joint inversion method. Therefore, traditional methods can no longer meet the requirements.

Geophysical image fusion refers to synthesizing or extracting information from two or more kinds of geophysical data (converted into images) to produce a strange output image, which contains all the image features related to the detection target and has higher visual and digital quality than any input image. Image fusion can be understood from two aspects: one is abstraction-wise, as a branch of data fusion. A typical application scenario is to map multiple data sets located at the same position into pixels of an image for clustering analysis when combined marks and patterns of deep prospecting are built. The other understanding is Algorithm-wise.

Image fusion is an extension of image analysis methods, and further includes other image processing tools, such as compression and coding, feature extraction, registration, identification and segmentation.

Image fusion can be divided into three levels: a data level, a feature level and a decision level. Pixel-level image fusion directly acts on the pixels of the image to obtain a final fusion image by combining the information of the same pixel size. Feature-level fusion involves multi-scale decomposition and signal decomposition and has significant advantages in feature extraction, and its main algorithms include pyramid decomposition, wavelet decomposition, etc. Decision-level fusion has strong fault tolerance and good openness, and its main algorithms include D-S evidence theory, expert systems, Bayesian estimation, etc. At present, the wavelet-based fusion algorithm is the most commonly used method in the geophysical field, but the wavelet-based image fusion method cannot describe the direction information of an image well.

### SUMMARY OF THE INVENTION

The present invention provides a geological target identification method and apparatus based on image information fusion, which comprehensively analyzes multi-source geophysical data with images as a carrier, ensures the accuracy and improves the efficiency of comprehensive interpretation at the same time.

In order to achieve the above invention purposes, the technical solution adopted by the present invention is as follows:

The present invention provides a geological target identification method based on image information fusion, including:
generating a first digital sectional map and a second digital sectional map of the same depth from a first data volume and a second data volume, respectively;
configuring data of the first digital sectional map and data of the second digital sectional map on a universal coordinate system respectively to form a first registered color map and a second registered color map;
pre-processing the first registered color map and the second registered color map respectively to form a first source image and a second source image;
decomposing the first source image into a first low frequency sub-band image and a first high frequency sub-band image, and decomposing the second source image into a second low frequency sub-band image and a second high frequency sub-band image;
fusing the first low frequency sub-band image and the second low frequency sub-band image to form a fused low frequency sub-band image; fusing the first high frequency sub-band image and the second high frequency sub-band image to form a fused high frequency sub-band image;
reconstructing the fused low frequency sub-band image and the fused high frequency sub-band image to obtain a fused image; and
segmenting the occurrence position of a geological body in the fused image by using a segmentation method to obtain a spatial occurrence form of a detection target;

The first data volume and the second data volume are geological data of a plurality of detection depths, and the geological data includes magnetic susceptibility data, resistivity data, density data, velocity data and polarizability data.

Optionally, decomposing the first source image into a first low frequency sub-band image and a first high frequency sub-band image, and decomposing the second source image into a second low frequency sub-band image and a second high frequency sub-band image includes:
decomposing the first source image and the second source image in scale respectively by using a non-subsampled pyramid filter bank to obtain a low frequency sub-band image and a high frequency sub-band image on each decomposition level;

The scale decomposition obtains K+1 sub-images equal in size to the first source image or the second source image, including K high frequency sub-band images and 1 low frequency sub-band image, where K is the number of decomposition levels.

Optionally, the method further includes:
performing l-level directional decomposition on the high frequency sub-band image by using a non-subsampled directional filter bank to obtain 2′ directional sub-images with the same size as the source image.

Alternatively, configuring data of the first digital sectional map and data of the second digital sectional map on a universal coordinate system respectively to form a first registered color map and a second registered color map includes:
configuring the data of the first digital sectional map and the data of the second digital sectional map on the universal coordinate system respectively according to grid positions to form the first registered color map and the second registered color map.

Optionally, pre-processing the first registered color map and the second registered color map respectively includes:
graying and normalizing the first registered color map and the second registered color map respectively.

Optionally, fusing the first low frequency sub-band image and the second low frequency sub-band image to form a fused low frequency sub-band image includes:
fusing the first low frequency sub-band image and the second low frequency sub-band image by using a fusion rule based on weighted average to form the fused low frequency sub-band image.

Optionally, fusing the first high frequency sub-band image and the second high frequency sub-band image to form a fused high frequency sub-band image includes:
fusing the first high frequency sub-band image and the second high frequency sub-band image by using a fusion rule based on a new metric parameter (NMP) to form the fused high frequency sub-band image.

Optionally, reconstructing the fused low frequency sub-band image and the fused high frequency sub-band image includes:
reconstructing the fused low frequency sub-band image and the fused high frequency sub-band image by using NSCT inverse transformation.

Optionally, segmenting the occurrence position of a geological body in the fused image by using a segmentation method to obtain a spatial occurrence form of a detection target includes:
setting a geological body occurrence position threshold for the fused image, and segmenting the occurrence position of the geological body in the fused image by using the segmentation method according to the set threshold to obtain the spatial occurrence form of the detection target.

On the other hand, the present invention further provides a geological target identification apparatus based on image information fusion, including an image generation module, an image fusion module and an information identification module; The image generation module is configured to generate a first digital sectional map and a second digital sectional map of the same depth from a first data volume and a second data volume, respectively; configure data of the first digital sectional map and data of the second digital sectional map on a universal coordinate system respectively to form a first registered color map and a second registered color map; and pre-process the first registered color map and the second registered color map respectively to form a first source image and a second source image; The image fusion module is configured to decompose the first source image into a first low frequency sub-band image and a first high frequency sub-band image, and decompose the second source image into a second low frequency sub-band image and a second high frequency sub-band image; fuse the first low frequency sub-band image and the second low frequency sub-band image to form a fused low frequency sub-band image; fuse the first high frequency sub-band image and the second high frequency sub-band image to form a fused high frequency sub-band image; and reconstruct the fused low frequency sub-band image and the fused high frequency sub-band image to obtain a fused image; The information identification module is configured to segment the occurrence position of a geological body in the fused image by using a segmentation method to obtain a spatial occurrence form of a detection target; The first data volume and the second data volume are geological data of a plurality of detection depths, and the geological data includes magnetic susceptibility data, resistivity data, density data, velocity data and polarizability data.

Compared with the prior art, the present invention has the following beneficial effects:
According to the method and apparatus of the present invention, a first digital sectional map and a second digital sectional map of the same depth are generated from a first data volume and a second data volume, respectively; data of the first digital sectional map and the second digital sectional map are configured on a universal coordinate system to form a first registered color map and a second registered color map; the first registered color map and the second registered color map are pre-processed to form a first source image and a second source image; the first source image and the second source image are respectively decomposed into a low frequency sub-band image and a high frequency sub-band image; the two low frequency sub-band images are fused; the two high frequency sub-band images are fused, the fused low frequency sub-band image and the fused high frequency sub-band image are reconstructed, and the occurrence position of a geological body in the fused image is segmented by using a segmentation method to obtain a spatial occurrence form of a detection target. In the present invention, the geological target identification comprehensively analyzes multi-source geophysical data with images as a carrier, realizes accurate identification and positioning of the target body under the condition of big data, and can ensure the accuracy and improve the efficiency of comprehensive interpretation at the same time.

### BRIEF DESCRIPTION OF THE DRAWINGS

FIG. 1 is a schematic flowchart of a geological target identification method based on image information fusion according to an embodiment of the present invention;

FIG. 2 is a schematic diagram of an NSPFB having three decomposition levels according to an embodiment of the present invention;

FIG. 3 is a schematic diagram of an NSDFB having four channels according to an embodiment of the present invention;

FIG. 4 is a schematic structural diagram of a geological target identification apparatus based on image information fusion according to an embodiment of the present invention;

FIG. 5 shows a registered magnetic susceptibility sectional map and resistivity sectional map according to an embodiment of the present invention, where FIG. 5 (a) is a registered magnetic susceptibility sectional map with a depth of 25 meters, and FIG. 5 (b) is a registered resistivity sectional map with a depth of 25 meters;

FIG. 6 shows a magnetic susceptibility source image and a resistivity source image according to an embodiment of the present invention, where FIG. 6 (a) is a magnetic susceptibility source image with a depth of 25 meters, and FIG. 6 (b) is a resistivity source image with a depth of 25 meters;

FIG. 7 shows a magnetic susceptibility low frequency sub-band image and a magnetic susceptibility high frequency sub-band image according to an embodiment of the present invention, where FIG. 7 (a) is a magnetic susceptibility low frequency sub-band image with a depth of 25 meters, and FIG. 7 (b) is a magnetic susceptibility high frequency sub-band image with a depth of 25 meters;

FIG. 8 shows a resistivity low frequency sub-band image and a resistivity high frequency sub-band image according to an embodiment of the present invention, where FIG. 8 (a) is a resistivity low frequency sub-band image with a depth of 25 meters, and FIG. 8 (b) is a resistivity high frequency sub-band image with a depth of 25 meters;

FIG. 9 shows a fused low frequency sub-band image and a fused high frequency sub-band image according to an embodiment of the present invention, where FIG. 9 (a) is a fused low frequency sub-band image with a depth of 25 meters, and FIG. 9 (b) is a fused high frequency sub-band image with a depth of 25 meters;

FIG. 10 is a fused image according to an embodiment of the present invention;

FIG. 11 is a three-dimensional fusion model map obtained based on NSCT according to an embodiment of the present invention; and

FIG. 12 is an altered rock thickness isoline map according to an embodiment of the present invention.

### DETAILED DESCRIPTION OF THE EMBODIMENTS

In order to make the purposes, technical solutions and beneficial effects of the present invention clearer, the embodiments of the present invention will be described below with reference to the accompanying drawings. It should be noted that the embodiments in the present application and the features in the embodiments may be combined with each other on a non-conflict basis.

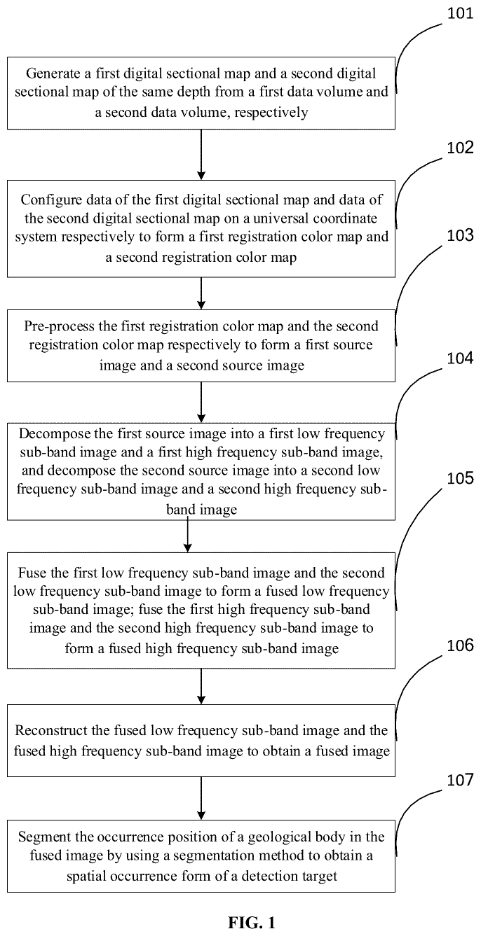

As shown in FIG. 1, an embodiment of the present invention provides a geological target identification method based on multi-source geophysical image information fusion, including:
S101, generating a first digital sectional map and a second digital sectional map of the same depth from a first data volume and a second data volume, respectively; S102, configuring data of the first digital sectional map and data of the second digital sectional map on a universal coordinate system respectively to form a first registered color map and a second registered color map; S103, pre-processing the first registered color map and the second registered color map respectively to form a first source image and a second source image; S104, decomposing the first source image into a first low frequency sub-band image and a first high frequency sub-band image, and decomposing the second source image into a second low frequency sub-band image and a second high frequency sub-band image; S105, fusing the first low frequency sub-band image and the second low frequency sub-band image to form a fused low frequency sub-band image; fusing the first high frequency sub-band image and the second high frequency sub-band image to form a fused high frequency sub-band image; S106, reconstructing the fused low frequency sub-band image and the fused high frequency sub-band image to obtain a fused image; and S107, segmenting the occurrence position of a geological body in the fused image by using a segmentation method to obtain a spatial occurrence form of a detection target; The first data volume and the second data volume are geological data of a plurality of detection depths, and the geological data includes magnetic susceptibility data, resistivity data, density data, velocity data and polarizability data.

In the embodiment of the present invention, a first digital sectional map and a second digital sectional map of the same depth are generated from a first data volume and a second data volume, respectively; data of the first digital sectional map and the second digital sectional map are configured on a universal coordinate system to form a first registered color map and a second registered color map; the first registered color map and the second registered color map are pre-processed to form a first source image and a second source image; the first source image and the second source image are respectively decomposed into a low frequency sub-band image and a high frequency sub-band image; the low frequency sub-band images are fused; the high frequency sub-band images are fused, the fused low frequency sub-band image and the fused high frequency sub-band image are reconstructed, and the occurrence position of a geological body in the fused image is segmented by using a segmentation method to obtain a spatial occurrence form of a detection target. In the present invention, the geological target identification comprehensively analyzes multi-source geophysical data with images as a carrier, realizes accurate identification and positioning of the target body under the condition of big data, and can ensure the accuracy and improve the efficiency of comprehensive interpretation at the same time.

The first data volume and the second data volume in the embodiment of the present invention may be any two of magnetic susceptibility data, resistivity data, density data, velocity data and polarizability data.

In the embodiment of the present invention, decomposing the first source image into a first low frequency sub-band image and a first high frequency sub-band image, and decomposing the second source image into a second low frequency sub-band image and a second high frequency sub-band image in step S104 includes:
decomposing the first source image and the second source image in scale respectively by using a non-subsampled pyramid filter bank to obtain a low frequency sub-band image and a high frequency sub-band image on each decomposition level; The scale decomposition obtains K+1 sub-images equal in size to the first source image or the second source image, including K high frequency sub-band images and 1 low frequency sub-band image, where K is the number of decomposition levels.

In the embodiment of the present invention, directional decomposition may also be performed after the scale decomposition, including:
performing l-level directional decomposition on the high frequency sub-band image by using a non-subsampled directional filter bank to obtain 21 directional sub-images with the same size as the source image.

Specifically, the scale decomposition and the directional decomposition are performed by a non-subsampled pyramid filter bank (NSPFB) and a non-subsampled directional filter bank (NSDFB), respectively.

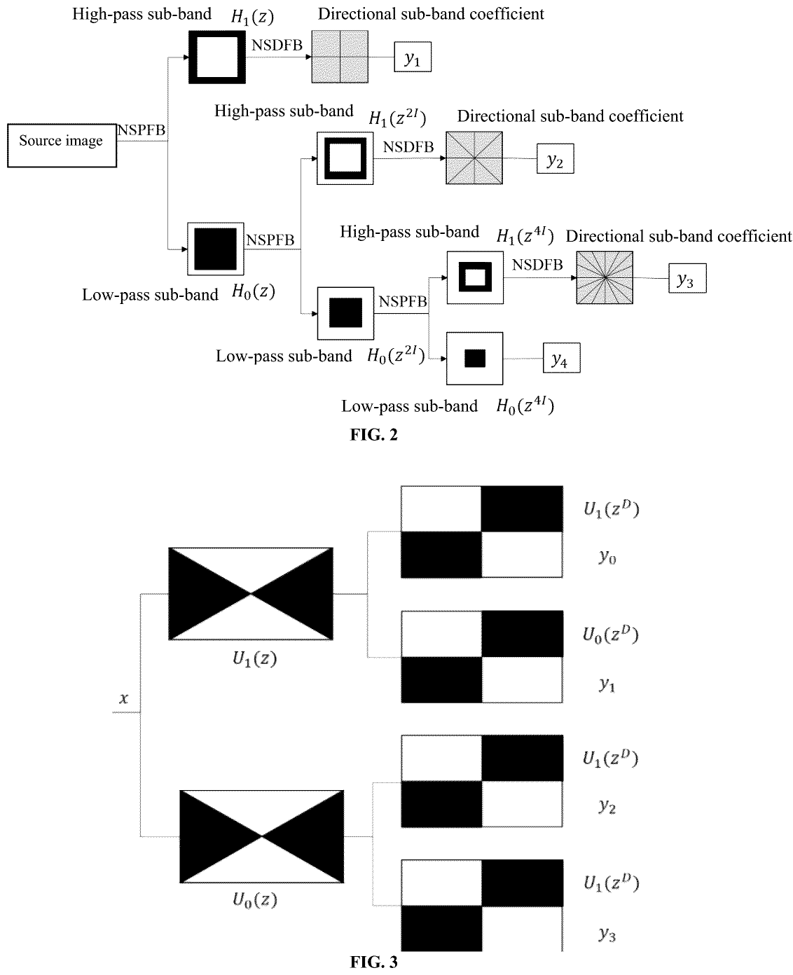

First, the NSPFB decomposes the normalized sectional maps (the first source image and the second source image) to obtain a low frequency sub-band image and a high frequency sub-band image on each decomposition level, thus realizing multi-scale decomposition. After NSPFB decomposition, K+1 sub-images with the same size as the source image are obtained, including K high frequency images and 1 low frequency image, where K is the number of NSPFB decomposition levels. FIG. 2 shows an NSPFB having three decomposition levels. The K-level cascaded equivalent filters of the NSPFB are as follows:

$${H}_{n} ( z ) = \{ \begin{matrix}{H}_{1} ( {z}^{{2}^{n - 1}} ) {\prod }_{k = 0}^{n - 2} {H}_{0} ( {z}^{{2}^{k}} ) , 1 \leq n \leq K \\ {\prod }_{k = 0}^{n - 2} {H}_{0} ( {z}^{{2}^{k}} ) , n = K + 1\end{matrix}$$

Herein, H₀(z) and H₁(z) represent corresponding low-pass and high-pass filters, respectively. Then, the NSDFB performs l-level directional decomposition on the high frequency sub-band image thereon to obtain 2′ directional sub-images with the same size as the source image, so that NSCT can obtain multi-directional characteristics and more accurate directional information.

FIG. 3 shows a four-channel NSDFB. FIG. 3 shows a complete four-channel non-subsampled directional filter bank (NSDFB). Uⱼ(z^{D})(j=0,1) represents a square filter, and Uᵢ(z)(j=0,1) represents a sector filter. When the output of the square filter Uⱼ(z^{D})(j=0,1) is combined with the output of the sector filter Uᵢ(z)(j=0,1) in the first step, the frequency decomposition in four directions can be obtained. The output result of the equivalent filter in each direction is Uₖ(z)=Uᵢ(z)Uⱼ(z^{D}). The synthesized filter is obtained in a similar way. All filter banks in an NSDFB tree structure are selected from a single non-subsampled sector filter bank. In order to realize multi-directional decomposition, the high-pass image obtained by NSDFB decomposition iteration needs to be further processed by NSPFB.

In step S101 of the embodiment of the present invention, both the first data volume and the second data volume are different detection data of multiple depths. In the embodiment of the present invention, a first digital sectional map and a second digital sectional map of N depths need to be generated, the data quantity M1 of the first data volume may be greater than or equal to N, the data quantity M2 of the second data volume may be greater than or equal to N, and finally both the first data volume and the second data volume contain the data corresponding to N depths.

In the embodiment of the present invention, configuring data of the first digital sectional map and data of the second digital sectional map on a universal coordinate system respectively to form a first registered color map and a second registered color map in step S102 includes:
configuring the data of the first digital sectional map and the data of the second digital sectional map on the universal coordinate system respectively according to grid positions to form the first registered color map and the second registered color map.

In the embodiment of the present invention, the first digital sectional map and the second digital sectional map are processed by data interpolation, sorting and coordinate transformation, so that the data of the first digital sectional map and the second digital sectional map of the same area are all on a universal coordinate system, and are strictly registered according to the grid positions to generate the first registered color map and the second registered color map.

In the embodiment of the present invention, pre-processing the first registered color map and the second registered color map respectively in step S103 includes:
graying and normalizing the first registered color map and the second registered color map respectively.

In the embodiment of the present invention, in step S103, the first source image is decomposed into a low frequency sub-band image and a high frequency sub-band image, and the second source image is decomposed into a low frequency sub-band image and a high frequency sub-band image, where the low frequency sub-band image may be one image or a few images, and the high frequency sub-band image may be one image or a few images. For example, the embodiment of the present invention adopts NSCT decomposition into four levels, where the first source image is decomposed into a low frequency sub-band image and a series of high frequency sub-band images (4 images); and the second source image is decomposed into a low frequency sub-band image and a series of high frequency sub-band images (4 images). The NSCT algorithm is fast transformation with translation invariance, multi-direction and multi-scale, and also has the properties of near neighbor sampling and local positioning, which can well depict high-dimensional information features of images. Therefore, the embodiment of the present invention adopts an image fusion method based on NSCT.

In the embodiment of the present invention, fusing the first low frequency sub-band image and the second low frequency sub-band image to form a fused low frequency sub-band image in step S105 includes: fusing the first low frequency sub-band image and the second low frequency sub-band image by using a fusion rule based on weighted average to form the fused low frequency sub-band image.

In the embodiment of the present invention, fusing the first high frequency sub-band image and the second high frequency sub-band image to form a fused high frequency sub-band image in step S105 includes: fusing the first high frequency sub-band image and the second high frequency sub-band image by using a fusion rule based on a new metric parameter (NMP) to form the fused high frequency sub-band image.

In the embodiment of the present invention, in step S105, the first low frequency sub-band image and the second low frequency sub-band image are fused by using the fusion rule based on weighted average to form the fused low frequency sub-band image (1 image); and the first high frequency sub-band image and the second high frequency sub-band image are fused by using the fusion rule based on a new metric parameter (NMP) to form fused high frequency sub-band images (4 images), where the number of fused images corresponds to the number of images during decomposition.

The weighted average fusion rule: the fusion purpose of this application is to fuse two groups of data volumes or models or images to obtain a unique information model, and then identify the position of an altered rock (low resistance and low magnetism) from this model. A low frequency sub-band image and a series of high frequency sub-band images will be obtained after NSCT decomposition of the source image. The low frequency sub-band image represents the structure component of the image, mainly reflects the average characteristics of geophysical images, and contains spectral information and most energy information of the image. Therefore, the embodiment of the present invention adopts the fusion rule based on weighted average. As shown in the following formula, the fusion rule mainly considers combining the average characteristics of two source images.

L(x,y)=α×L_{Mag}(x,y)+β×L_{Res}(x,y),α+β=1

Herein, α and β are positive weighting coefficients; L(x,y) is a component of the final fused image; L_{Mag}(x,y) and L_{Reg}(x,y) are respectively components of the first source image and the second source image (or components of the first data volume and the second data volume). The weighting coefficients α and β determine the proportion of information occupied by different models. In order to extract the best information from the data, these parameters need to be analyzed to determine appropriate coefficients. Considering the accuracy of first data volume and second data volume inversion models in this embodiment, the two parameters are respectively set to α=0.25 and β=0.75.

The NMP fusion rule is composed of phase congruency (PC), a measure of local sharpness change (LSCM) and local energy (LE), where PC is used to describe the sharpness of a target body in an image, LSCM is used to reflect a local contrast of the image and LE is used to supplement local brightness information.

NMP(x,y)=(PC(x,y))^{α}^{₁}·(LSCM(x,y)))^{β}^{₁}·(LE(x,y))^{γ}^{₁}

Herein, PC(x,y), LSCM (x,y) and LE (x,y) are respectively parameters of PC, LSCM and LE, α₁, β₁, γ₁ are parameters used to adjust the PC, LSCM and LE in the NMP, and α₁, β₁, γ₁ are weighting coefficients without physical meanings. In the embodiment of the present invention, the parameters α₁, β₁, γ₁ are respectively set to 1, 2 and 2.

PC is a dimensionless parameter, and is used to describe the importance of image features. In the high frequency sub-band image, the PC value corresponds to the sharpness of the target body in the image. Because the image can be considered as a two-dimensional signal, the PC value at (x,y) can be calculated according to the following formula:

$$P C ( x , y ) = \frac{{\sum }_{k} {E}_{{θ}_{k}} ( x , y )}{ε + {\sum }_{n} {\sum }_{k} {A}_{n , {θ}_{k}} ( x , y )}$$

Herein, θₖ represents a direction angle at k, A_{n,θ}_{ₖ} represents the n-th Fourier component and the direction angle θₖ and indicates the amplitude of the n-th Fourier component when the direction angle is θₖ, and ε represents a normal number of a direct current component with image signals removed. In the fusion framework of the embodiment of the present invention, the parameter ε is set to 0.001. E_{θ}_{ₖ} (x,y) represents local energy, which can be calculated by the following formula.

$${E}_{{θ}_{k}} ( x , y ) = \sqrt{{F}_{{θ}_{k}}^{2} ( x , y ) + {H}_{{θ}_{k}}^{2} ( x , y )}$$

$$\{ \begin{matrix}{F}_{{θ}_{k}} ( x , y ) = {\sum }_{n} {e}_{n , {θ}_{k}} ( x , y ) \\ {H}_{{θ}_{k}} ( x , y ) = {\sum }_{n} {o}_{n , {θ}_{k}} ( x , y )\end{matrix}$$

Herein, e_{n,θ}_{ₖ}(x,y) and o_{n,θ}_{ₖ} (x,y) are convolution values of an input image at (x,y), which can be calculated by the following formula:

└e_{n,θk}(x,y),o_{n,θ}_{ₖ}(x,y)┘=[I(x,y)*Mₙ^{e},I(x,y)*Mₙ⁰]

Herein, I(x,y) is a pixel value at (x,y), Mₙ^{e},Mₙ⁰ are two-dimensional log-Gabor symmetric filters at the n level, and [ ] is a representation of the symmetric filters.

However, PC is a contrast invariant and does not reflect local contrast changes. In order to make up for the shortcomings of PC, a calculation method of sharpness change (SCM) is provided in the following formula.

$$SCM ( x , y ) = {\sum }_{( {x}_{0} , {y}_{0} ) ∈ {Ω}_{0}} ( I ( x , y ) - I ( {x}_{0} , {y}_{0} ) )$$

Herein, SCM(x,y) represents a parameter of a sharpness change measure, and Ω₀ represents a 3×3 local area input at (x,y). (x₀, y₀) represents a pixel in the local area Ω₀. Meanwhile, in order to calculate a neighborhood contrast of (x,y), a measure of local sharpness change (LSCM) is introduced in the embodiment of the present invention, and a calculation method of the LSCM is provided in the following formula.

$$LSCM ( x , y ) = {\sum }_{a = - M}^{M} {\sum }_{b = - N}^{N} SCM ( x + a , y + b )$$

In the formula, LSCM(x,y) represents a parameter of the current sharpness change measure, and (2M+1)×(2N+1) represents the size of a neighborhood.

Because LSCM and PC cannot fully reflect local luminance information, local energy (LE) is introduced, which can be calculated by the following formula.

$$LE ( x , y ) = {\sum }_{a = - M}^{M} {\sum }_{b = - N}^{N} {( I ( x + a , y + b ) )}^{2}$$

Herein, LE(x,y) represents current energy parameter. After an NAM is obtained, the fused high frequency sub-band image can be calculated by the rule provided in the following formula.

$${H}_{F} ( x , y ) = \{ \begin{matrix}{H}_{A} ( x , y ) , {ifLamp}_{A} ( x , y ) = 1 \\ {H}_{A} ( x , y ) , otherwise\end{matrix}$$

Herein, H_{F}(x,y), H_{A}(x,y) and H_{B}(x,y) are respectively high frequency sub-band images of a fused image and source images I_{A} and I_{B}. Lampᵢ(x,y) represents a decision map of high frequency sub-band image fusion, which can be calculated by the following formula.

$${Lamp}_{i} ( x , y ) = \{ \begin{matrix}1 , & if [ {S}_{i} ( x , y ) ] > \frac{\tilde{M} \times \tilde{N}}{2} \\ 0 , & otherwise\end{matrix}$$

Sᵢ(x,y)=(x₀,y₀)∈Ωᵢ|NMPᵢ(x₀,y₀)≥max(NMP₁(x₀,y₀) . . . ,NMPᵢ₋₁(x₀,y₀) . . . NMP_{K}(x₀,y₀))

Herein, Ω₁ represents a \tilde{M}×Ñ sliding window centered on (x,y), and K is the number of source images.

In the embodiment of the present invention, reconstructing the fused low frequency sub-band image and the fused high frequency sub-band image in step S106 includes:
reconstructing the fused low frequency sub-band image and the fused high frequency sub-band image by using NSCT inverse transform. NSCT is composed of NSPFB and NSDFB, and the decomposition and inverse transformation of NSCT correspond to the decomposition and reconstruction of NSPFB and NSDFB respectively. NSCT inverse transformation is actually the reconstruction process of NSPFB and NSDFB. The main formulas are as follows:

### NSPFB Reconstruction:

$${H}_{0} ( z ) {H}_{1} ( z ) + {G}_{0} ( z ) {G}_{1} ( z ) = 1$$

$${H}_{n} ( z ) = \{ \begin{matrix}{H}_{1} ( z ) {\prod }_{j = 0}^{n - 2} {H}_{0} ( {z}^{j} ) , 1 \leq n \leq {2}^{k} \\ {\prod }_{j = 0}^{n - 1} {H}_{0} ( {z}^{j} ) , n = {2}^{k}\end{matrix}$$

Herein, j is the number of decomposition levels, H₀(z) and H₁(z) are decomposition filters in NSPFB, and G₀(z) and G₀(z) are reconstruction filters in NSPFB.

### NSDFB Reconstruction:

$${U}_{0} ( z ) {U}_{1} ( z ) + {V}_{0} ( z ) {V}_{1} ( z ) = 1$$

$${U}_{n} ( z ) = \{ \begin{matrix}{U}_{1} ( z ) {\prod }_{j = 0}^{n - 2} {U}_{0} ( {z}^{j} ) , 1 \leq n \leq {2}^{k} \\ {\prod }_{j = 0}^{n - 1} {U}_{0} ( {z}^{j} ) , n = {2}^{k}\end{matrix}$$

Herein, j is the number of decomposition levels, U₀(z) and U₁(z) are decomposition filters in NSPFB, and Vo (z) and Vo (z) are reconstruction filters in NSDFB.

In the embodiment of the present invention, segmenting the occurrence position of a geological body in the fused image by using a segmentation method to obtain a spatial occurrence form of a detection target in step S107 includes:
setting a geological body occurrence position threshold for the fused image, where the occurrence position threshold is designated according to some prior data, such as borehole information and an outcrop target body; and segmenting the occurrence position of the geological body in the fused image by using the segmentation method according to the set value to obtain the spatial occurrence form of the detection target.

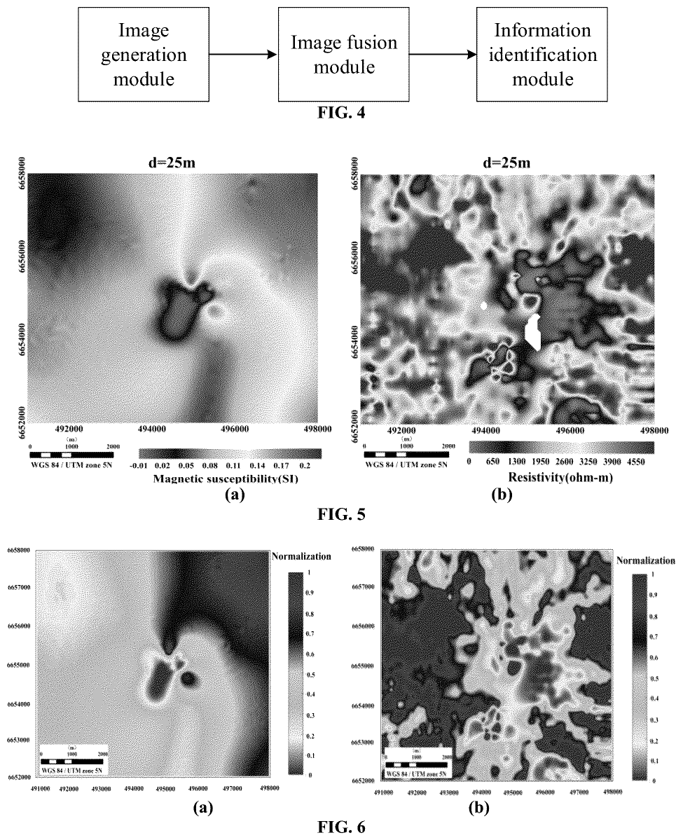

In the second aspect, as shown in FIG. 4, the present invention further provides a geological target identification apparatus based on image information fusion, including an image generation module, an image fusion module and an information identification module;
The image generation module is configured to generate a first digital sectional map and a second digital sectional map of the same depth from a first data volume and a second data volume, respectively; configure data of the first digital sectional map and data of the second digital sectional map on a universal coordinate system respectively to form a first registered color map and a second registered color map; and pre-process the first registered color map and the second registered color map respectively to form a first source image and a second source image;
The image fusion module is configured to decompose the first source image into a first low frequency sub-band image and a first high frequency sub-band image, and decompose the second source image into a second low frequency sub-band image and a second high frequency sub-band image; fuse the first low frequency sub-band image and the second low frequency sub-band image to form a fused low frequency sub-band image; fuse the first high frequency sub-band image and the second high frequency sub-band image to form a fused high frequency sub-band image; and reconstruct the fused low frequency sub-band image and the fused high frequency sub-band image to obtain a fused image;
The information identification module is configured to segment the occurrence position of a geological body in the fused image by using a segmentation method to obtain a spatial occurrence form of a detection target;
The first data volume and the second data volume are geological data of a plurality of detection depths, and the geological data includes magnetic susceptibility data, resistivity data, density data, velocity data and polarizability data.

### EXAMPLE

In this example, the measured airborne electromagnetic detection and aeromagnetic detection data in the ILIAMNA volcanic area are taken as an example to carry out inversion modeling. The first data volume is airborne electromagnetic inversion data; and the second data volume is aeromagnetic inversion data.

Image Generation from Multi-Source Geophysical Data
1. Digital sectional maps of 9 depths (d=25 m, 75 m, 125 m, 175 m, 225 m, 275 m, 325 m, 375 m, 425 m) are generated from an inverted magnetic susceptibility model and an inverted resistivity model;
2. The 9 digital sectional maps are pre-processed by data interpolation, sorting and coordinate transformation, so that two types of data in the same area are strictly registered on a universal coordinate system according to grid positions to generate a registered magnetic susceptibility sectional map and a registered resistivity sectional map (taking source images of d=25 m here as an example), as shown in FIG. 5.
3. The registered magnetic susceptibility sectional map and and resistivity sectional map are grayed and normalized respectively to form a magnetic susceptibility source image and a resistivity source image. See FIG. 6.

### Image Fusion of Multi-Source Geophysical Data

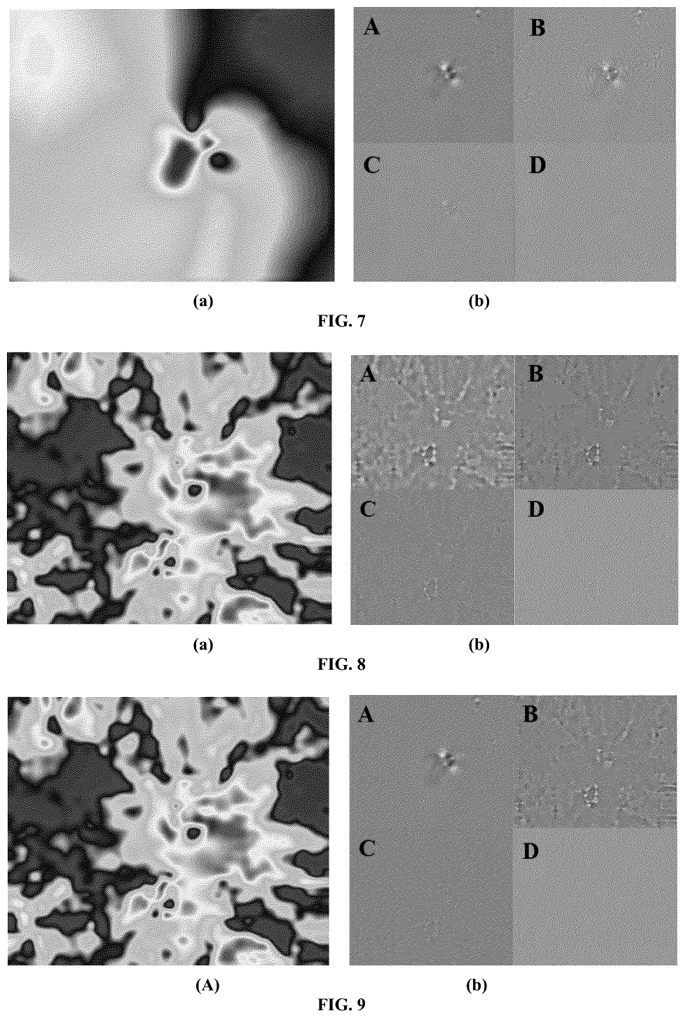

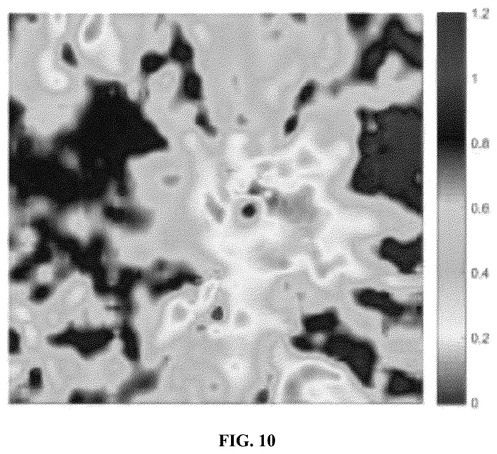

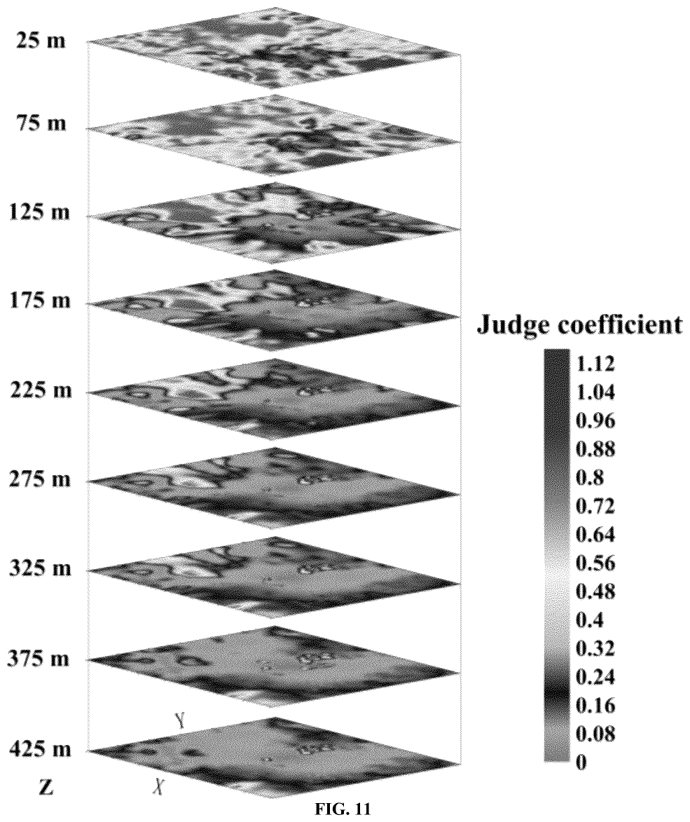

1. NSCT decomposition. In the example of the present invention, the number of decomposition levels is 4, so the magnetic susceptibility source image is decomposed into a magnetic susceptibility low frequency sub-band image (1 image, see FIG. 7a) and a series of magnetic susceptibility high frequency sub-band images (4 images, see FIG. 7b); and the resistivity source image is decomposed into a resistivity low frequency sub-band image (1 image, see FIG. 8a) and a series of resistivity high frequency sub-band images (4 images, see FIG. 8b).
2. Fusion. The magnetic susceptibility low frequency sub-band image and the resistivity low frequency sub-band image are fused by using a fusion rule based on weighted average to form a fused low frequency sub-band image (1 image, see FIG. 9a); and the magnetic susceptibility high frequency sub-band images and the resistivity high frequency sub-band images are fused by using a fusion rule based on a new metric parameter (NMP) to form fused high frequency sub-band images (4 images, see FIG. 9b).
3. Inverse transformation. The fused low frequency sub-band image and high frequency sub-band images are reconstructed by using NSCT inverse transformation to obtain a single fused image (FIG. 10). Sectional maps with different depth information are fused by the same method. Finally, a 3D fusion model map is obtained (FIG. 11).

### Information Identification of Multi-Source Geophysical Images

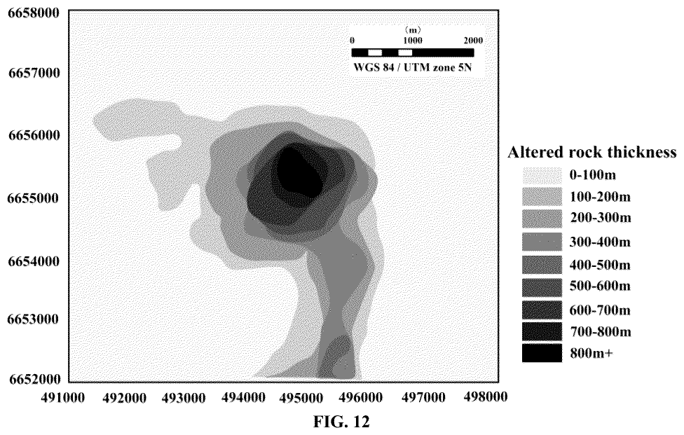

After the source images of different depths are fused by an image fusion module to obtain fused images with different depth information, target bodies in the series of fused images are segmented by using a threshold segmentation method to obtain a spatial occurrence form of a detection target (FIG. 12), where the pixel thresholds are all 45.

Although the disclosed embodiments of the present invention are as above, the contents thereof are only employed for the convenience of understanding the technical solution of the present invention, and are not intended to limit the present invention. Any technician in the technical field to which the present invention belongs can make any modification and variation in the implementation form and details without departing from the core technical solution disclosed by the present invention, but the protection scope defined by the present invention is still subject to the scope defined by the attached claims.

1. A geological target identification method based on image information fusion, comprising:
generating a first digital sectional map and a second digital sectional map of the same depth from a first data volume and a second data volume, respectively;
configuring data of the first digital sectional map and data of the second digital sectional map on a universal coordinate system respectively to form a first registered color map and a second registered color map;
pre-processing the first registered color map and the second registered color map respectively to form a first source image and a second source image;
decomposing the first source image into a first low frequency sub-band image and a first high frequency sub-band image, and decomposing the second source image into a second low frequency sub-band image and a second high frequency sub-band image;
fusing the first low frequency sub-band image and the second low frequency sub-band image to form a fused low frequency sub-band image; fusing the first high frequency sub-band image and the second high frequency sub-band image to form a fused high frequency sub-band image;
reconstructing the fused low frequency sub-band image and the fused high frequency sub-band image to obtain a fused image; and
segmenting the occurrence position of a geological body in the fused image by using a segmentation method to obtain a spatial occurrence form of a detection target;
wherein the first data volume and the second data volume are geological data of a plurality of detection depths, and the geological data includes magnetic susceptibility data, resistivity data, density data, velocity data and polarizability data.

2. The method according to claim 1, wherein decomposing the first source image into a first low frequency sub-band image and a first high frequency sub-band image, and decomposing the second source image into a second low frequency sub-band image and a second high frequency sub-band image comprises:
decomposing the first source image and the second source image in scale respectively by using a non-subsampled pyramid filter bank to obtain a low frequency sub-band image and a high frequency sub-band image on each decomposition level, wherein
the scale decomposition obtains K+1 sub-images equal in size to the first source image or the second source image, including K high frequency sub-band images and 1 low frequency sub-band image, where K is the number of decomposition levels.

3. The method according to claim 2, further comprising:
performing l-level directional decomposition on the high frequency sub-band image by using a non-subsampled directional filter bank to obtain 2′ directional sub-images with the same size as the source image.

4. The method according to claim 2, wherein configuring data of the first digital sectional map and data of the second digital sectional map on a universal coordinate system respectively to form a first registered color map and a second registered color map comprises:
configuring the data of the first digital sectional map and the data of the second digital sectional map on the universal coordinate system respectively, and performing registration according to grid positions to form the first registered color map and the second registered color map.

5. The method according to claim 2, wherein pre-processing the first registered color map and the second registered color map respectively comprises:
graying and normalizing the first registered color map and the second registered color map respectively.

6. The method according to claim 2, wherein fusing the first low frequency sub-band image and the second low frequency sub-band image to form a fused low frequency sub-band image comprises:
fusing the first low frequency sub-band image and the second low frequency sub-band image by using a fusion rule based on weighted average to form the fused low frequency sub-band image.

7. The method according to claim 2, wherein fusing the first high frequency sub-band image and the second high frequency sub-band image to form a fused high frequency sub-band image comprises:
fusing the first high frequency sub-band image and the second high frequency sub-band image by using a fusion rule based on a new metric parameter (NMP) to form the fused high frequency sub-band image.

8. The method according to claim 2, wherein reconstructing the fused low frequency sub-band image and the fused high frequency sub-band image comprises:
reconstructing the fused low frequency sub-band image and the fused high frequency sub-band image by using NSCT inverse transformation.

9. The method according to claim 1, wherein segmenting the occurrence position of a geological body in the fused image by using a segmentation method to obtain a spatial occurrence form of a detection target comprises:
setting a geological body occurrence position threshold for the fused image, and segmenting the occurrence position of the geological body in the fused image by using the segmentation method according to the set threshold to obtain the spatial occurrence form of the detection target.

10. A geological target identification apparatus based on image information fusion, comprising: an image generation module, an image fusion module and an information identification module, wherein
the image generation module is configured to generate a first digital sectional map and a second digital sectional map of the same depth from a first data volume and a second data volume, respectively; configure data of the first digital sectional map and data of the second digital sectional map on a universal coordinate system respectively to form a first registered color map and a second registered color map; and pre-process the first registered color map and the second registered color map respectively to form a first source image and a second source image;
the image fusion module is configured to decompose the first source image into a first low frequency sub-band image and a first high frequency sub-band image, and decompose the second source image into a second low frequency sub-band image and a second high frequency sub-band image; fuse the first low frequency sub-band image and the second low frequency sub-band image to form a fused low frequency sub-band image; fuse the first high frequency sub-band image and the second high frequency sub-band image to form a fused high frequency sub-band image; and reconstruct the fused low frequency sub-band image and the fused high frequency sub-band image to obtain a fused image; and
the information identification module is configured to segment the occurrence position of a geological body in the fused image by using a segmentation method to obtain a spatial occurrence form of a detection target;
wherein the first data volume and the second data volume are geological data of a plurality of detection depths, and the geological data includes magnetic susceptibility data, resistivity data, density data, velocity data and polarizability data.
